(19) United States
(12) Patent Application Publication
(10) Pub. No.: US 2008/0315829 A1
(43) Pub. Date: Dec. 25, 2008

(54) Power Supply Systems for Electrical Devices

(76) Inventors: Stuart Micheal Ruan Jones, Herts (GB); David Murray Cross, Herts (GB); Timothy Michael Wood, Herts (GB)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 11/884,160

(22) PCT Filed: Feb. 10, 2006
(86) PCT No.: PCT/GB06/00477

§ 371 Date: Feb. 11, 2008

(30) Foreign Application Priority Data
Feb. 11, 2005 (GB) 0502923.6

(51) Int. Cl. H02J 7/34

(52) U.S. Cl. 320/103

(57) ABSTRACT

An electrically powered portable device, the device including means for providing a function to be performed by the device, an electrical power supply which incorporates in combination a voltage source and at least one capacitor for storing electrical charge to power the device, the voltage source and the at least one capacitor being arranged so that the voltage source progressively charges the at least one capacitor for any period that the at least one capacitor is not fully charged, and electronic control circuitry to control electrical power drawn from the electrical power supply for driving the function providing means.

The present invention relates generally to power supply systems for portable electrical devices. The present invention also relates to replaceable power sources for such a portable electrical device.

Many liquids (and a few powders) need to be made into a finely dispersed aerosol at the point of use for best effect. Examples include household air fresheners, cleaning products, deodorants, asthma inhalers, paint, cosmetics, perfumes etc. To create an aerosol the liquid needs to be broken up from a constant stream into fine individual droplets. This requires significant energy input to overcome the cohesive forces holding a liquid together. Conventionally the creation of an aerosol is achieved either a) by forcing the liquid at high pressure through a small nozzle, at the discharge of which the flow breaks up into droplets; or b) by combining a gas and liquid stream in a nozzle to create droplets. Low viscosity liquids can produce an aerosol by method a) but as the viscosity rises or as smaller droplets are required, then it is necessary to add the extra energy of the gas stream in method b).

By way of example, many household products are packaged in ‘aerosol’ cans which use a gaseous propellant (e.g. butane or a chlorofluorocarbon (CFC)) to create the mist of product.

There are also examples of solid products that are used in a ‘dust cloud’ of powder similar to a liquid aerosol (e.g. dry-powder inhalers).

Compressed gas aerosol cans suffer from a number of well recognised disadvantages inherent in this packaging format. For example, it is necessary to provide a propellant gas in addition to the product, which adds cost. The gas requires a high pressure container (typically rated to 6 bar and above) which brings cost, complexity in manufacture, the need for an effective closure/spray nozzle and safety issues. The pressure requirement also restricts the shape and form of the pack. In some applications the gas is undesirable from a product formulation and usage standpoint e.g. medical inhalation devices. It can be difficult to solubilise certain formulations, which impacts in product stability, shelf life, a requirement to shake the contents prior to emission, and in some situations may preclude certain molecular systems.

The propellant gases based on CFC's are notoriously environmentally unfriendly, butane is highly flammable, and there are few suitable gases with the right physical properties for this use having minimal environmental impact. For medical use some propellants are undesirable due to their inherent properties and potential effect on the patient. The gas is normally present as a liquid inside the aerosol can but the available pressure is temperature dependant, and decreases toward the end of the pack life. Aerosol cans have been designed with internal bags to prevent the gas discharging, but these are more expensive, and do not produce such a fine droplet size.

Alternatively a ‘trigger spray’ device is used, where squeezing a trigger by hand results in a coarse droplet discharge. The force available in a trigger spray is limited to what the consumer can generate by hand, and so the pressure, and therefore the performance, are user dependent. Also, only low viscosity liquids are suitable for trigger sprays. The resultant discharge is a coarse spray rather than a true aerosol, with a relatively high variation in droplet size. The spray patterns and droplet size varies significantly between users and over time, based on the forces exerted. Consumers quickly tire of using a trigger and the pack is not suited to repetitive use. Also, there are a large number of components in the trigger adding cost to the pack. A trigger spray pack has limited pack integrity, as packs equilibrate by allowing air back into the pack. They are generally non-hermetically sealed systems.

From the above it can be seen that there is a technical need, and a significant commercial need, for a simple and cheap means of producing an aerosol or spray, without use of propellant gas or manual effort.

Many household electrical products require low power to deliver their specific function e.g. household delivery devices. Household delivery devices are used for the release of a range of volatile actives, including their use in delivery of air fresheners and pest control products. Such devices manifest themselves in a variety of forms that can generally be divided into passive and active systems. The latter incorporate an energy source to boost the release of actives and enable the effective use of lower volatile molecules. Other household electrical products require higher power delivery but for short times e.g. (remove since high powered device probably not applicable to area of invention), electric razors, toothbrushes, torches etc. Such devices are generally mains or battery driven.

Electrical mains powered or plug-in electrical systems meet the needs where a continuous power source is required with relatively high power usage. However such devices have a number of consumer negatives, such as: they occupy a mains outlet socket; they restrict the location opportunities for placing the product; and for certain products such as vaporisers, they reduce the opportunity for maximum effectiveness, i.e. hidden behind furniture, away from the bed etc; they may not be suitable for UK bathrooms where safe power sockets (shaver outlets) are not so common; and/or they require electrical leads which trail, get in the way and can become hazardous with wear and tear.

Plug-in household delivery devices suffer from the additional problem that being hidden, they are difficult to get to, adjust and can lay empty for some time before this is noticed.

As an alternative and to provide increased portability, a large number of battery operated devices have been developed. These utilise a range of battery technologies and are either disposable or rechargeable.

A number of battery operated household delivery devices have launched (for example, SC Johnson's “Glade Wisp” and Air Wick's Mobil'Air air fresheners).

The use of batteries however, is often seen as a negative by the consumer since it necessitates another consumable element, which has a negative environmental impact, adds on-going cost and can easily be forgotten to be replace or recharged, rendering the device inactive. Additionally batteries have a number of inherent characteristics i.e. high weight; adds bulk to the product, low power density.

Re-chargeable batteries address some of the above issues, although many of the inherent negatives still exist, such as: high weight; low power density (although NiCd cells address the power density issue to some extent); environmentally unfriendly; relatively slow re-charge rate even for “rapid charge” systems; and/or re-charge memory, limiting charge capacity if recharge regime is not followed and leading to reduced life expectancy of products where the rechargeable cells are not user replaceable.

In addition for air freshening and pest control devices, battery systems that utilise rechargeable technologies have historically been rejected since the time to recharge the battery cells can be significant. Air freshening and pest control is normally seen as an instantly reactive activity rather than one that you have several hours to plan, therefore within these product categories, the power source must to be able to instantly respond to a need, rather than being inoperable during a recharge cycle.

Many portable household and healthcare electrical devices are battery operated and require higher power for short times e.g. household electrical devices, such as: small vacuum cleaners, DIY power tools s, carving knives, personal grooming products including electric razors, hair clippers and manicure products, torches; and healthcare electrical devices, such as: injectors, actuated blood glucose meters, inhalers, and wireless communications from drug compliance aids and monitors, etc. Other devices are currently non battery operated and take their power from other sources such as aerosol and springs but with better use of electrical energy delivery may also be applicable to this invention.

Known hand held electric razors are either mains or battery powered, a number of the more expensive razors are powered by rechargeable batteries and typically claim a three minute quick charge feature. However, the need for batteries adds bulk, both size and weight, to the hand held razor. A three minute quick charge is still relatively slow compared with the preferred embodiment described here. Some known electric razors have accessories that can be conveniently stored on a base unit.

Other portable household and healthcare electrical devices require low power to deliver their specific function e.g. household delivery devices, non-actuated blood glucose meters, etc.

Devices that deliver higher power for short times are more demanding of their energy sources. Batteries for such portable devices are generally rated to supply the peak power, to achieve minimum voltage drop, and prolong battery life.

As is known to a person skilled in the art, the voltage output from a battery progressively drops as the battery supplies energy. The voltage drop under peak power from batteries increases rapidly with device operation cycle. It would be desirable to be able to prolong useful battery life to provide a particular function of an electrically powered device.

Some electrically powered devices are operated progressively to consume consumables that are provided with the device. The consumables need to be replaced individually after each use, or more conveniently a number of consumables are provided in a single package. The single package can be loaded into the device to provide a number of future use cycles in a single recharge operation, or alternatively individual consumables may be unpackaged and individually loaded into the device. When the electrically powered device is battery operated, the user needs to remember to replace the battery, when discharged, below a critical level as well as the consumables. The life cycle of the battery and the consumables is generally different, so the user needs to remember to replace them at different times. Sometimes the device may not be working properly, because the battery may be partially discharged, or alternatively the user may dispose of the battery when replacing the consumables before the useful battery life has been reached, which is wasteful.

The invention aims to provide household and healthcare electrical devices having a power source capable of being fast charged.

This invention aims to provide a power source designed to efficiently provide for intermittent high pulse power needs of household and medical devices. The invention further aims to provide electrical devices, in particular household and healthcare electrical devices, which have a power source that can provide improved performance as compared to known devices.

The invention also aims to provide a more effective supply of a battery and consumables for an electrically powered device.

According to a first aspect of the present invention there is provided an electrically powered portable device, the device including means for providing a function to be performed by the device, an electrical power supply which incorporates in combination a voltage source and at least one capacitor for storing electrical charge to power the device, the voltage source and the at least one capacitor being arranged so that the voltage source progressively charges the at least one capacitor for any period that the at least one capacitor is not fully charged, wherein the voltage source continuously provides electrical power to at least one first component of the function providing means and the at least one capacitor intermittently provides high electrical power to at least one second component of the function providing means, and electronic control circuitry to control electrical power drawn from the electrical power supply for driving the function providing means.

The electrically powered portable device may comprise a household delivery device such as an air freshener or pest control device, a vacuum cleaner, a kitchen appliance, such as an electric carving knife, a personal grooming product such as an electric razor, a hair clipper, an electric toothbrush or a manicure product, a torch, a power tool, such as a paint and/or adhesive applicator or remover, or a healthcare electrical device, such as a injector, an actuated blood glucose meter, an inhaler, and a wireless communications device from a drug compliance aid and/or monitor, etc.

Such devices are not limited to those identified above, which are used purely as illustration, but could also take the form of a variety of hand held portable powered cleaning products, kitchen utensils, personal grooming products etc characterised by either: medium power portable devices used for a relatively short time i.e. for illustration electric razors, torches, whisks, hair clippers, two-way pagers, GSM-protocol cell phones, hand-held GPS-systems; power tools and small vacuum cleaners. etc., or lower powered portable devices that may be continuous, pulsed or used intermittently and for which having to wait an extended period of time for recharging provides significant inconvenience, i.e. household delivery device etc.

The at least one capacitor preferably comprises at least one super-capacitor. The term “super-capacitor” is known to persons skilled in the art. In this specification, the term “super-capacitor” means a capacitor that has a capacitance of at least 1 Farad, most typically from 1 to 50 Farads, and preferably stores electrical charge electrostatically.

Preferably, the or each capacitor has a capacitance of from 1 to 50 Farads, more preferably for devices which deliver extended pulse lengths or have higher energy needs from 10 to 50 Farads or for devices which deliver short pulses with lower energy needs from 1-10 Farads. Preferably, the at least one capacitor has a working output voltage of from 0.8V to 3.6V.

In a preferred embodiment there is provided a portable device, in particular a delivery device for the release of volatile actives such as air fresheners and pest control products, which utilises as a power source at least one fast charge super-capacitor.

In accordance with this aspect of the present invention therefore, the invention is predicated on the finding that for applications where a small quantity of product (liquid or powder) is required at one time in an aerosolised form, then an electrically powered spray is a particularly attractive solution, overcoming the problems with known aerosol systems discussed hereinbefore. In order to provide the necessary delivery of a high power output for a short time period, the present invention combines a super-capacitor into the device to provide a much higher power energy source compared with a battery alone. In a portable unit, the use of a super-capacitor enables a smaller, lighter, more effective and potentially a lower cost device than would be possible with a battery alone.

Although the super-capacitor provides the instantaneous source of power to propel the fluid at time of use, it is not a requirement that all the components are fixed into a single device. The power might be supplied by a permanently installed battery, a removable one, or even mains supply, and the product reservoir might be a single long lasting unit or individual replaceable doses. For ease of use in different applications, these components may be supplied and assembled in any combination.

Super-capacitors inherently have a number of attributes that make them suitable for providing power for such portable devices, such as: very rapid charge (<15 seconds, ideally 2-15 seconds and more ideally 2-5 seconds); can be cycled thousands of times without detrimental effects or reduced life (no chemical reactions); light weight; high power density; extremely low internal impedance for high power, low loss charging and discharging; compact energy source (e.g. for a delivery device typically half the size of an AA battery for 2 to 4 hours use); the shape and dimensions can be readily customised for relatively low sales volumes; and environmentally friendly, allowing for improved alignment of the device manufacturers with proposed European recycling and transportation legislations specifically related to batteries and battery powered products.

Capacitors store energy in the form of separated electrical charge. The greater the area for storing charge, and the closer the separated charges, the greater the capacitance. A super-capacitor gets its area from a porous carbon-based electrode material which has much greater area than a conventional capacitor that has flat or textured films and plates. A super-capacitor's charge separation distance is determined by the size of the ions in the electrolyte which is much smaller than conventional dielectric materials.

The combination of enormous surface area and extremely small charge separation gives the super-capacitor its outstanding capacitance relative to conventional capacitors.

A super-capacitor stores energy electrostatically by polarising an electrolytic solution. There are no chemical reactions involved in its energy storage mechanism. The mechanism is therefore efficient and highly reversible.

A battery will store much more energy than the same size super-capacitor but in applications where power determines the size of the energy storage device, a super-capacitor may be a better solution. The super-capacitor is able to deliver frequent pulses of energy without any detrimental effects (small capacitors can deliver over 10 amps). Many batteries experience reduced life if exposed to frequent high power pulses. The super-capacitor can be charged extremely quickly. Many batteries are damaged by fast charging. The super-capacitor can be cycled hundreds of thousands of times. Batteries are generally capable of only a few hundred to a few thousand cycles depending on the chemistry.

Many applications can benefit from the use of super-capacitors, from those requiring short power pulses, to those requiring low power support of critical memory systems.

The super-capacitors can be used alone, or in combination with other energy sources.

Super-capacitors have unique user benefits and provide greater flexibility in new product designs. Benefits include: very high efficiency; long cycle and application life; fast charge/discharge; high power capability (high current for up to 10 seconds); life extension for other energy sources e.g. battery; durable and flexible design (fit for rugged environments); wide temperature range (−35 to +65° C.); low maintenance; straightforward integration; cost effective, and available in high volume.

By providing the capacitance and low equivalent resistance of a capacitor in parallel with a battery, which has much higher internal impedance than a capacitor, the super-capacitor can be designed to support the battery and deliver the required peak power for short times. Super-capacitors are particularly good at providing peak power. A capacitor in parallel with a battery can significantly reduce voltage drop under peak power and extend battery life.

The size of the super-capacitor will be dependant on the device needs and will ideally drive the device for the period of the expected need of the device.

The present invention has particular application for use in medical devices, in particular medical devices that are required to deliver a high electrical power for a short duration, for example to drive a motor, a solenoid or an actuator. Typically, such devices are required to supply such high electrical power intermittently for short periods of time, and may comprise, for example, blood glucose meters, injectors or spikes, inhalers, pumps, compliance aids and monitors (which may provide an output via a wireless communication), low power surgical devices, such as for us in ophthalmic, orthopedic, derma abrasion, chiropody and dentistry applications, and wound dressings, for example providing an additional monitoring or smart delivery function The medical devices may be designed to provide a single operation cycle from a single charge or multiple operation cycles as may be desired by the function of the device. The medical devices may also incorporate a coded trigger linked to the charging action, or burst wireless communications.

Most preferably, the medical device comprises a power supply comprising the combination of a voltage source, such as at least one battery, which may be disposable or rechargeable, and the at least one capacitor, with the voltage source and the at least one capacitor being arranged so that the voltage source substantially continually progressively charges the at least one capacitor for any period that the at least one capacitor is not fully charged. This provides that the capacitor can be used, rather than the voltage source, intermittently to provide the required high power for a short duration, but is substantially continually recharged by the voltage source.

The pulse of high electrical power from the at least one capacitor may be triggered by the user, for example manually, e.g. by pressing a button. Alternatively, the pulse of high electrical power from the at least one capacitor may be triggered automatically, for example from a timing circuit or another control system.

According to a second aspect of the present invention there is provided a replaceable package for an electrically powered portable device, which package comprises, in combination, a battery pack, comprising one or more disposable batteries, and a consumable pack comprising a plurality of consumable doses, either individually packaged or in a bulk form, for emission by the electrically powered portable device.

According to a third aspect of the present invention there is provided an electrical power source for an electrically powered portable device, which power source comprises, in combination, a battery pack, comprising one or more disposable batteries, at least one capacitor electrically connected to the battery pack, a voltage regulator for regulating the output voltage of the at least one capacitor, the voltage regulator being adapted to output a voltage having a value substantially the same as the voltage of the at least one capacitor when fully charged, and output terminals for the power source electrically connected to the at least one capacitor.

According to a fourth aspect of the present invention there is provided an electrically powered portable medical inhaler, the medical inhaler comprising function providing means including a solenoid arranged directly or indirectly to aerosolise a unit dose of an inhalation medicament for inhalation, an electrical power supply which incorporates in combination a voltage source and at least one capacitor for storing electrical charge to power the inhaler, the voltage source and the at least one capacitor being arranged so that the voltage source progressively charges the at least one capacitor for any period that the at least one capacitor is not fully charged, wherein the at least one capacitor intermittently provides pulses of high electrical power to at least the solenoid, and electronic control circuitry to control electrical power drawn from the electrical power supply for driving the function providing means.

According to a fifth aspect of the present invention there is provided an electrically powered portable spray device for generating an aerosol spray of a product, the spray device comprising a reservoir for the product, a nozzle for discharging a spray, a delivery device to deliver the product from the reservoir to the nozzle, an aerosol spray generator for producing an aerosol spray of the product at the nozzle, an electrical power supply which incorporates in combination a voltage source and at least one capacitor for storing electrical charge to power the device, the voltage source and the at least one capacitor being arranged so that the voltage source progressively charges the at least one capacitor for any period that the at least one capacitor is not fully charged, wherein the at least one capacitor intermittently provides high electrical power to at least the aerosol spray generator, and electronic control circuitry to control electrical power drawn from the electrical power supply for driving at least the aerosol spray generator.

According to a sixth aspect of the present invention there is provided an electrically powered portable medical injector, the medical injector comprising an injection means, an electrical power supply which incorporates in combination a voltage source and at least one capacitor for storing electrical charge to power the injector, the voltage source and the at least one capacitor being arranged so that the voltage source progressively charges the at least one capacitor for any period that the at least one capacitor is not fully charged, wherein the at least one capacitor intermittently provides pulses of high electrical power to the injection means, and electronic control circuitry to control electrical power drawn from the electrical power supply for driving the injection means.

According to a seventh aspect of the present invention there is provided a medical inhaler in the form of an aerosol generating device, the medical inhaler comprising an electrical power source including a battery in parallel with a supercapacitor to provide output terminals connected to an actuator, the actuator is coupled to a piston disposed in a cylinder having an outlet in the form of a dosing orifice, a container containing a supply of a drug to be dispensed is connected to the cylinder, a dosing device is provided at the outlet of the container to dispense a measured dose of the drug into the cylinder, and the dosing orifice has a predetermined shape and dimension to generate an aerosol when the measured amount of the drug is expressed therethrough under pressure from the action of the piston operated by the actuator.

Embodiments of the present invention will now be described by way of example only with reference to the accompanying drawings, in which:—

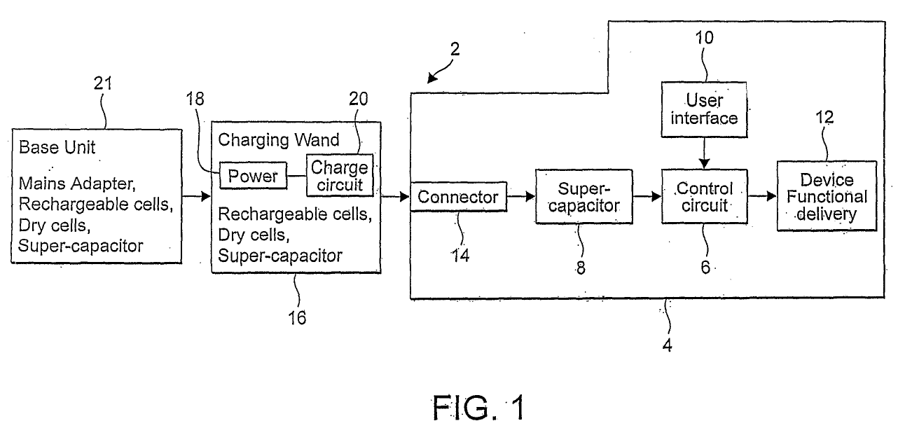

FIG. 1 is a schematic block diagram of a charging system for a portable electronic device in accordance with a first embodiment of the present invention, the system including a portable charging wand and a portable device chargeable by the portable charging wand;

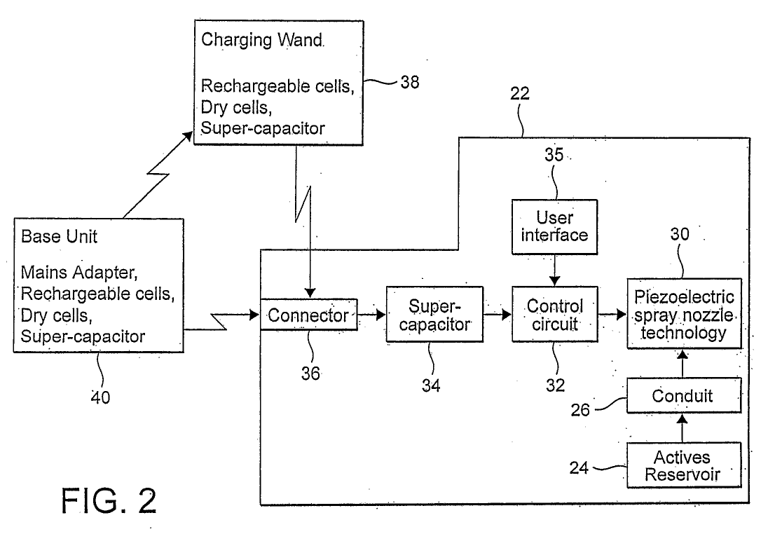

FIG. 2 is a schematic block diagram of a charging system for a portable electronic device in the form of a delivery device in accordance with a second embodiment of the present invention, the system including a portable charging wand and a delivery device, the delivery device being chargeable by the portable charging wand or a base unit;

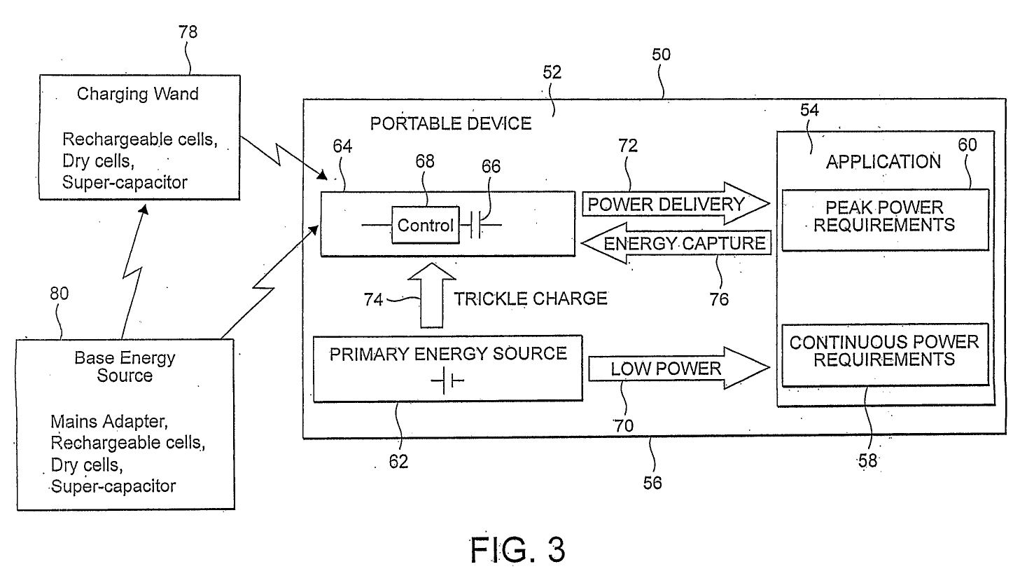

FIG. 3 is a schematic block diagram of a charging system for a portable electronic device in accordance with a third embodiment of the present invention;

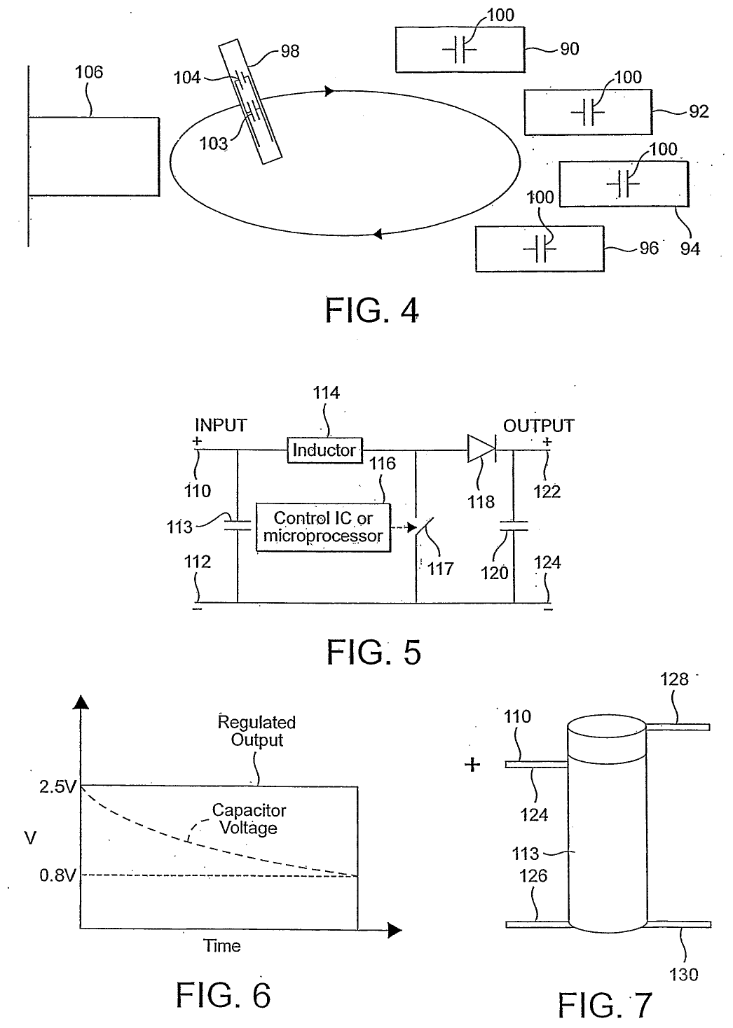

FIG. 4 is a schematic diagram of a charging system for a plurality of portable electronic devices in accordance with a fourth embodiment of the present invention; these devices may be of a common or different design, each having control circuitry to manage the charge transferred from the wand so as to meet its own specific needs;

FIG. 5 is a schematic diagram of a voltage regulator system in combination with a capacitor to provide a power supply for a portable electronic device in accordance with a fifth embodiment of the present invention;

FIG. 6 is a graph showing the relationship between output voltage and time for the power supply of FIG. 5;

FIG. 7 is a block diagram of the power supply of FIG. 5, illustrating how a voltage regulator may be packaged with the super capacitor;

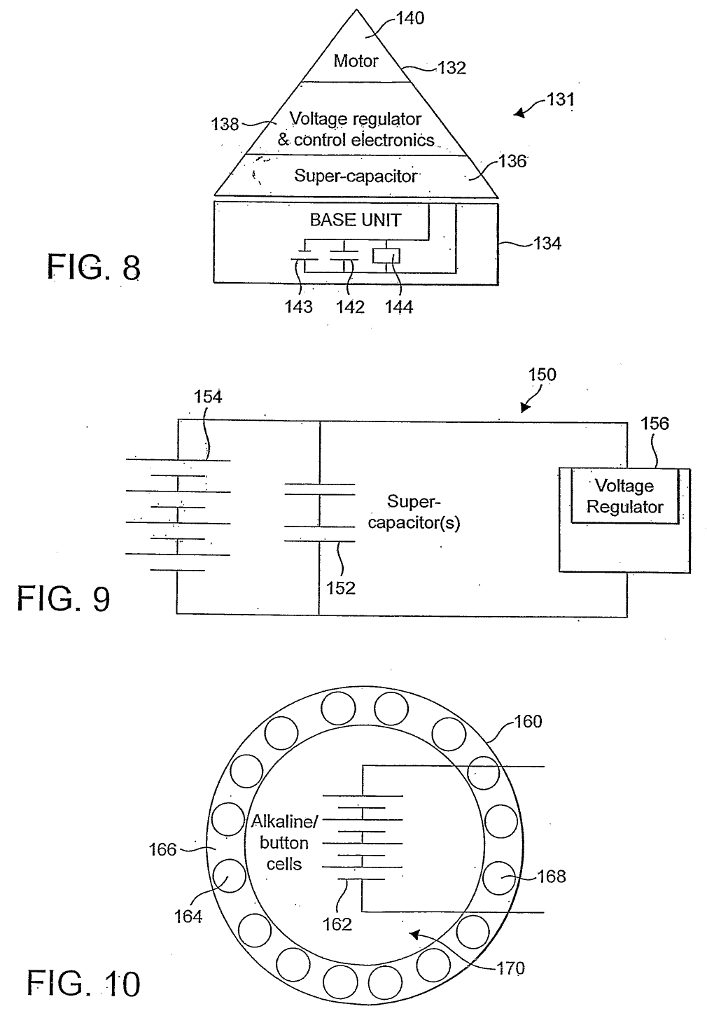

FIG. 8 is a schematic diagram of an electric razor and base unit having a power supply in accordance with a sixth embodiment of the present invention;

FIG. 9 is a schematic diagram of a power supply for a portable electronic device in accordance with a seventh embodiment of the present invention;

FIG. 10 is a schematic diagram of a package containing consumables and at least one battery for a portable electronic device in accordance with an eighth embodiment of the present invention; and

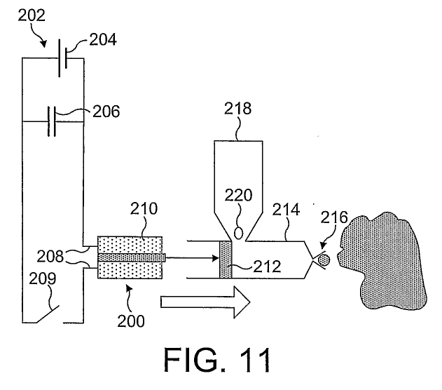

FIG. 11 is a schematic diagram of an aerosol generating device in accordance with another embodiment of the present invention.

Referring to FIG. 1, in a first preferred embodiment of the present invention the rapid charge system, designated generally as 2, includes: a powered device 4 having a control circuit 6 to control the function of the device 4. The powered device 4 may be a delivery device and the control circuit 6 may act to control the duration of pulses and/or time between pulses so as to increase or reduce the rate of fluid dispense and the period between charges. A super-capacitor 8 is connected to the control circuit 6 to comprise a power source, using one or more super-capacitors capable of fast recharge, and to provide electrical power to the powered device 4, the control circuit 6 also functioning to regulate constant power from the super-capacitor 8 as it discharges. The device 4 has a user interface 10 and an element 12 delivering the function of the device, for example a spray mechanism. The device 4 may also be provided with a re-charge indicator (not illustrated); and/or an On/Off control (not illustrated), or alternatively the device may not have an On/Off switch or a recharge indicator.

In this embodiment the device 4 regulates delivery when the super-capacitor 8 has sufficient charge and stops spraying when there is insufficient charge to power the device when the active has expired or when the control terminates spraying.

The device has a connector 14, acting as a charge point for the super-capacitor 8, to make electrical contact with a portable charging wand 16. Preferably, the recharge interface has a total impedance of not more than 0.3 Ohms. The portable charging wand 16 contains an electrical power source 18 comprising either batteries or another super-capacitor that can be carried around to rapidly recharge multiple portable devices around the home. When the electrical power source 18 comprises another super-capacitor it preferably has a higher capacitance than that of the super-capacitor 8 in the device 4 to be charged by the recharging wand 16. The recharging wand 16 contains circuitry 20 to rapidly charge one or more devices 4 suitable for household delivery. The device 4 and recharging wand 16 each have bodies to meet aesthetic and functional requirements of the product. The device 4 has a docking station, incorporating the connector 14, for the recharging wand 16, which can trickle charge or fast charge depending on the needs of the recharging wand 16. The electrical power source 18 of the wand 16 is in turn charged by selective docking with a base unit 21, which may be mains or battery powered, the latter using dry or rechargeable batteries, and/or may also have a super-capacitor for storing electrical charge for delivery to the wand 16. For the wand 16, preferably at least one of the input and output electrical connectors comprises low impedance contacts, having an impedance of not more than 0.2 Ohms, and the wand 16 has a total impedance of not more than 0.3 Ohms.

The wand can incorporate: re-chargeable batteries, trickle charged through a docking station plus suitable control circuitry which can in turn provide the super capacitors within the device or devices with high current flow and therefore provide for rapid charging through a simple electrical mating operation; and/or master super capacitors with high power rating charged from docking station plus suitable control circuitry which can in turn provide the super capacitors within the device or devices with high current flow and therefore provide for rapid charging through a simple electrical mating operation.

The charging wand may comprises batteries, or high capacitance capacitors (generally known as super-capacitors), or a combination of battery, super-capacitor, and protection and voltage regulator control electronics.

To increase the energy that can be transferred to the device and stored in the device's super-capacitor, and increase the functional and economic suitability of super-capacitors for the purpose(s) described herein, the wand would be able to charge the capacitor in the device to typically 3.6V which is greater than the rated working voltage of the super capacitors (typically 2.5V) specified by the manufacturer.

Once charged the power source will ideally drive the delivery device for the required period of time this will be dependent on the average power required to deliver the active—a function of the quantity of active that is required to be delivered, its associated volatility and the delivery method being used. This could take the form of a, pulsed fan system or more ideally low power piezoelectric spray nozzle technology. To extend the period of time between charges i.e. up to 10 days a control circuit having an on/off pulse mode could be included, the frequency and duration of the pulse being tailored to meet the specific needs of the product.

Referring to FIG. 2 in a second preferred embodiment of the present invention a delivery device 22 consists of: a reservoir 24 to contain the active to be emanated; a conduit 26 to transfer the active from the reservoir 26 to a delivery surface (not shown); a powered delivery means 30, preferably a piezoelectric spray nozzle (other embodiments may use a variety of other delivery mechanisms such as heaters, fans, mechanically activated aerosol spray; etc); a control circuit 32, to control the duration of spray pulses and/or time between sprays so as to increase or reduce the rate of fluid dispense and the period between charges (ideally the time between sprays is from 30 seconds to 30 minutes with a dispense volume of 0.01 mg-0.5 mg per pulse), and a power source 34, using one or more super-capacitors capable of fast recharge. The control circuit 32 acts to regulate constant power from the one or more super-capacitors 34 during discharge. A user interface 35 connects to the control circuit 32. A re-charge indicator and/or an On/Off control may be provided, or alternatively the device 22 may not have an On/Off switch or a recharge indicator, in which embodiment the device 22 starts when the super-capacitor 34 has sufficient charge and stops spraying when there is insufficient charge to power the device or the active has expired. A connector 36 is provided connected to the super-capacitor(s) 34, acting as a charge point selectively to make electrical contact with a portable charging wand 38, or a base charging unit 40 comprising a wireless recharge station, or a docking station at a mains electricity outlet. The portable charging wand 38 may contain either rechargeable batteries or another, preferably larger, super-capacitor that can be carried around to rapidly recharge multiple portable delivery devices around the home. In other embodiments, the portable charging wand could be replaced by a more permanent docking base charging unit 40, which could be mains or battery driven. The recharging wand 38 or base charging unit 40 contains circuitry to rapidly charge devices 22 suitable for household delivery. The device 22 has a body for the device to meet aesthetic and function requirements, and the recharge wand 38 and/or docking base charging unit 40 have a body to meet aesthetic and function requirements.

In this embodiment, as in other embodiments directed to an electrically-powered aerosol generating device that does not employ a propellant gas, the reservoir 24 typically comprises a container, substantially un-pressurised, for holding the product which is the active to be emanated. For liquid products which require a high level of integrity, then a collapsible flexible bag or pouch may be provided, either containing multiple doses solution or constituting an individual single dose unit.

As disclosed in detail with respect to other embodiments, in addition to the super-capacitor 34, the an electrically-powered aerosol generating device includes an additional power source such as a battery, which is selected and/or configured to provide the total energy required over the life of the product. The battery may be part of the consumable element, namely the reservoir of the product, and the battery energy capacity may be matched to the needs to the number of doses. The battery may be rechargeable. Alternatively, the super-capacitor 24 could be charged before each use from the base unit 40 or the wand 38 (each being additionally or alternatively either battery or mains powered).

The super-capacitor 34 has sufficient size and rating to provide enough energy for one or more consecutive product ‘bursts’ dependant on the application . . . . As an alternative to the piezoelectric spray nozzle, any alternative powered delivery means 30 of converting the electrical energy into fluid flow at the desired high pressure and flow rate may be employed, such as a displacement pump, a solenoid, or another mechanical actuator. The control circuit 32 comprises electronics to control power/energy transfer and where necessary support other design requirements such as counters, lights, warning signals, timers etc. The powered delivery means 30 includes a discharge nozzle, suitably designed to produce the required discharge flow characteristics (e.g. spray or aerosol) from the liquid under the pressure and flow rate required. The device is provided with any associated components required to make up a complete device, for example a consumer pack.

A further embodiment of the electrically powered portable charging device of the invention in combination with a further electrically powered portable device of the invention is shown in FIG. 3.

FIG. 3 shows a schematic drawing of a portable device chargeable by a portable charging device comprising a charging wand and/or a base source of energy comprising a base charging unit which portable device uses a super-capacitor. By way of example, the portable device may be a household delivery device; an electric razor; or a medical injector device. Such devices are not limited to those identified above, which are used purely as illustration, but could also take the form of a variety of hand held powered cleaning products, kitchen utensils, personal grooming, and medical healthcare products, etc., characterised by either: medium power portable devices used for a relatively short time, for illustration these could include electric razors, torches, whisks, hair clippers, diabetes control devices, etc., or lower powered portable devices that may be continuous, pulsed or used intermittently and for which having to wait an extended period of time for recharging provides significant inconvenience, for illustration this could be a household delivery device, etc.

The portable device, designated generally as 50, comprises a power module 52 integrated with an application module 54 in a common housing 56. The application module 54 comprises all the elements required to provide the device with the required functionality, for example motors, sensors, switches, displays, etc. Some elements have continuous power requirements, as represented by box 58, which require relatively low electrical power, for example to power a display or a clock whereas other elements have intermittent peak power requirements, as represented by box 60, which require relatively high electrical power for short periods of time, for example to drive a pulsed motor. In this embodiment, a primary energy source 62, typically comprising at least one battery, is provided, and this is arranged to provide the continuous low electrical power, represented by arrow 70, to the elements in box 58 which have continuous power requirements. A secondary energy source 64, comprising at least one storage capacitor 66, typically a super-capacitor, is also provided, and this is arranged to provide the peak high electrical power, represented by arrow 72, to the elements in box 60 which have intermittent peak power requirements. The secondary energy source 64 also incorporates a power control 68. The power control 68 regulates an incoming trickle charge, represented by arrow 74, from the primary energy source 62 to the at least one storage capacitor 66, and also regulates the outgoing power delivery, represented by the arrow 72, from the secondary energy source 64 to the application module 54. The power control 68 also regulates any incoming energy capture, represented by arrow 76, from the application module 54 to the at least one storage capacitor 66.

Optionally, the secondary energy source 64 may additionally be relatively rapidly charged (as compared to the trickle charge from the primary energy source 62) as shown in FIG. 3, by a portable charging wand 78 and/or by a base charging unit 80. As for the previous embodiments, the portable charging wand 78 can electrically mate with one or more portable powered household or medical devices having the electronics and circuitry developed so as to provide for very rapid re-charge in a consumer friendly way. The wand 78 may comprise at least one super-capacitor for storing charge to be delivered to the super-capacitor 66 in the device 52. The wand 78 may alternatively or additionally incorporate: replaceable primary cells, replaceable rechargeable cells, or non-replaceable re-chargeable batteries, which may themselves be adapted to be trickle charged through a docking base charging unit 80. The wand 78 would have control circuitry which provides the super-capacitor(s) 66 within the or each device 52 with high charging current flow and therefore provide for rapid charging of the super-capacitor(s) 66 by the wand 78 through a simple electrical mating operation. Such powered devices 52 are ideally suited to the use of fast charge super-capacitors 66 as the internal power source. Similarly, the docking base charging unit 80 may comprise one or more master super-capacitors with high power rating charged from a power source within the docking base charging unit 80, together with control circuitry to provide the super-capacitor(s) 66 within the device 52 with high current flow and therefore provide for rapid charging through a simple electrical mating operation.

When for example the device 52 is a household delivery device, the capacitance and therefore the physical size of the super-capacitor(s) 66 of the secondary energy source 62 would be dependant on the device needs and would ideally drive the device 52 for the expected discharge period for the active contained in the device 52, or until a consumer acceptable time between recharges of the device 52 has elapsed. This period would be dependent on the average power required to deliver the active, which is a function of the quantity of active that is required to be delivered, its associated volatility and the delivery method being used. The delivery mechanism of the application module 54 could take the form of a pulsed fan system, piezoelectric spray nozzle technology or aerosol spray technology. The period between charging could be increased by appropriate selection of the delivery cycle.

There follow example calculations, based on currently available air freshener devices. For an air freshener requiring average power of 6.8 mW per hour, for a super-capacitor having a capacitance of 80 Farads, this would provide three hours operating time per day for a total of three days, and the super-capacitor of the device would require recharging after three days. For an air freshener requiring average power of 4.6 mW per hour, for a super-capacitor having a capacitance of 60 Farads, this would provide three hours operating time per day for a total of three days, and the super-capacitor of the device would require recharging after three days. For an air freshener requiring average power of 4.6 mW per hour, for a super-capacitor having a capacitance of 60 Farads, this would provide one hour of operating time per day for a total of nine days, for example by providing a 30 second delivery period every 6 minutes for 12 hours per day, and the super-capacitor of the device would require recharging after nine days.

When the device is a medical injector device, this may comprise a needle-less injector or an auto-injector, both being an alternative to a hypodermic syringe.

Needle-less injectors generate a high velocity stream of product which penetrates the skin without any mechanical intrusion (i.e. no needle is provided) Such a device has a lower power duty to the aerosol system described above and as such a smaller capacitor would be envisaged. A short burst of high energy is needed to power the jet for a single ‘injection’ followed by a period of inactivity. The combination of the primary energy source 62 consisting of a battery, and the super-capacitor 66 in the second energy source 64 is well suited to this power requirement of a needle-less injector. There is a similar power requirement to be correspondingly matched to a high pressure/flow generator for conveying the product to be injected to the jet device, for example a pump, solenoid, or other electromechanical device.

To improve the procedure of injecting a drug by use of a hypodermic syringe, especially if the procedure is to be carried out by the patient themselves, automatic injection systems are currently being developed. In such a system, the injector device, incorporating a hypodermic needle, is held in position above the skin and the needle is pushed into the skin automatically, generally through the mechanical action of a spring under compression. After the injection of the needle into the patient's skin. a drug is automatically pumped through the needle at a controlled rate. The power duty of such an auto-injector is again for a short duration pulse of power, to achieve the needle injection and the subsequent drug administration, followed by a period of rest. Either or both the movement of the needle and the pumping of the drug could be carried out by the secondary power source 64 comprising the super-capacitor 66, charged by the battery of primary power source 62. Alternatively, the auto-injector may simply incorporate a super-capacitor that is electrically driven by a base station, a wand, and/or mains electricity as described earlier.

In both of the medical injector devices described above, the super-capacitor offers commercial and medical advantages over alternative power/energy sources, e.g. mechanical springs, high pressure gas charges, etc. that are less suited to re-priming by the user.

Other similar portable medical devices in which a short power cycle is followed by a period of rest, where a small battery re-charges a supercapacitor, are other drug delivery or diagnostic devices with intermittent use or any portable device where the duty cycle may not be ideally matched to the electrical power being provided only by a battery.

In a particularly preferred embodiment of a household delivery device, multiple delivery devices 90, 92, 94, 96 (e.g. air fresheners, these may or may not be of common design or have common power requirements) are sequentially charged from a wand 98, as shown in FIG. 4. As for the previous embodiments, the wand 98 comprises at least one super-capacitor 103 and/or one or more high current rated batteries 104. The super-capacitor 103 sources the peak power transfer to each of the delivery devices 90, 92, 94, 96 in turn. The wand 98 contacts with each delivery device 90, 92, 94, 96 in turn and rapidly transfers charge (ideally for a period of 2-15 seconds), direct from the batteries 104, or the larger capacitor 103, in the wand 98 to the smaller capacitor 100 in each delivery device 90, 92, 94, 96. When present, the wand capacitor 103 may be recharged from the wand battery 104 between charge transfers to each delivery device 90, 92, 94, 96. The wand capacitor 103/battery 104 recharges from a base charger unit 106 that may comprise larger batteries or preferably a mains plug-in charging unit.

In this embodiment, a typical delivery device requires 200 J based on 3 hours operation per day, for 3 days. In total therefore a total energy of 800 J needs to transfer from a wand 98 that charges four delivery devices 90, 92, 94, 96. Allowing 60 seconds between each charging of a delivery device 90, 92, 94, 96 for the wand capacitor 102 to recharge from the wand battery 104, requires 3.3 W power transfer, or about 0.9 A from three 1.2V AAA size rechargeable NiCd or NiMH batteries. Three AAA NiMH 750 mAh batteries have sufficient energy to charge about forty delivery devices before the wand batteries require recharge. The wand requires at least a 60F capacitor, assuming the three 1.2V batteries charge the capacitor to 3.6V just prior to charge transfer. Each delivery device takes energy from the wand until the wand and device are at the same voltage, typically 2.5V. Control electronics within the wand ensures that the super-capacitor is not left charged to 3.6V for more than 60 seconds prior to discharge. (Super-capacitors are damaged if left voltage stressed for extended time periods beyond the manufacturer's maximum voltage specification, typically 2.5V).

In a yet further embodiment of a household delivery device, as each device delivers active energy is taken from the capacitor and its voltage decays, control electronics within each delivery device is designed to boost the decaying voltage and regulate the voltage to the load. The regulated voltage depends on the load (e.g. fan, piezo spray nozzle, etc). Piezo spray technology may require significantly higher voltage (15V) than a fan motor (2.4V).

FIG. 5 shows a schematic representation of an example of a voltage regulator for use in the invention.

An input direct current (DC) voltage source is provided between terminals 110,112, the voltage source comprising a super-capacitor 113. An inductor 114 is in series with one terminal 110 and a control integrated circuit or microprocessor 116, controls a high-frequency (typically 100 kHz) switch 117, is in parallel with the DC voltage source, and serial arrangement of a diode 118 and a capacitor 120 is in parallel with the switch 117 controlled by the control integrated circuit or microprocessor 116, and the capacitor 120 has two output terminals 122, 124 thereacross. The general structure of such a voltage regulating circuit, absent the super-capacitor as the voltage source, is known per se.

The output voltage may be preset as a single value, or multiple output voltages may be provided.

In accordance with the invention, the input direct current (DC) voltage source provided between terminals 110,112 is from a super-capacitor 113 in the device which provides electrical power to the device, for example super-capacitor 100 in the previous embodiment. The voltage regulator acts to regulate the output voltage so as to provide constant output voltage even with varying input voltages. For example, the super-capacitor may have a nominal output voltage of 2.5 volts when fully charged. As the device is used, the stored electrical charge in the super-capacitor progressively diminishes, and the voltage of the super-capacitor progressively diminishes correspondingly. For example, the voltage may decrease with usage from 2.5 to 0.8 volts. This is shown in FIG. 6. If the super-capacitor output comprises the input for the voltage regulator, the input voltage varies between 0.8 to 2.5 volts from the super-capacitor. However, the regulated output voltage may be maintained at 2.5 volts. The power output would typically be about 10 mW. Therefore the voltage regulator acts to extend the useful life per charge for the super-capacitor power supply for use in the devices of the present invention, for example delivery devices, or personal grooming devices.

The super-capacitor and voltage regulator may be structured as shown in FIG. 7. The super-capacitor 113 and voltage regulator 122 are integrated to form a single packaged element, typically cylindrical or prismatic, having fast-charge input terminals 124, 126 connected across the super-capacitor 113 and regulated voltage output terminals 128, 130 connected across the combined circuit of the super-capacitor 113 and the voltage regulator 122. This provides the combination of a rapid charge with a regulated voltage output, thereby providing constant output power. This single packaged element of a voltage regulated capacitor power source may be made and sold separately for incorporation into powered devices. It may retain the external shape and dimensions commonly used for batteries thereby making it readily incorporated into powered devices.

In accordance with a further embodiment of the invention, as shown in FIG. 8 an electric razor system 131 comprises a razor 132 and a base unit 134. At least one super-capacitor 136 stores energy in the razor 132, and there are no batteries in the razor. The base unit 134 either comprises at least one super-capacitor 142 and battery 143 in combination and/or is mains powered (not shown), and has control electronics 144 to control the voltage output. The razor 132 interfaces with the base unit 134 via very low impedance contacts. The base unit 134 rapidly transfers energy to the razor 132 when electrical contact is made therebetween. Control electronics 138, including a voltage regulator, in the razor 132 boosts and regulates the voltage to the razor motor 140 to achieve constant power and sufficient blade speed to prevent hair snagging.

In one particular example, the razor super-capacitor 136 is specified to have a capacitance of at least 60F based on requirements for 2 W motor power for the razor motor 140 and three minute usage prior to recharge. The razor super-capacitor 136 is initially charged to 3.6V from control electronics 144 in the base unit. The razor super-capacitor 136 delivers 360 J to the load as its voltage decays from 3.6V to an assumed 0.8V cut-off. The base unit comprises four 1.2V NiCd or NiMH batteries, or has a plug-in mains adapter to isolate and convert AC mains voltage to 4.8V DC. The base unit 134 also comprises two super-capacitors specified at 140F each and connected in series to provide 70F at 4.8V. Energy is transferred from the base super-capacitor to the razor super-capacitor. In this example, 360 J are transferred within 10 seconds. Charging is complete when the voltages on the razor super-capacitor and base super-capacitor are equal.

In an alternative embodiment, and because the larger capacitors in the base unit are currently rather expensive, three rechargeable batteries in the base may directly charge the razor capacitor to 3.6V but more slowly e.g. within 30 seconds.

In either embodiment control electronics within the razor ensures that the super-capacitor is not left charged to 3.6V for more than 60 seconds prior to discharge. This is because super-capacitors are damaged if the applied voltage is higher than the manufacturer's max voltage specification, typically 2.5V, for significant periods of time.

A yet further embodiment of a powered device in accordance with the invention comprises a medical device. There are a number of mechanical and battery powered medical devices on the market these include: delivery devices such as injectors, inhalers, etc; sampling and measuring devices, such as glucose monitors; and device compliance monitoring and communication devices. Medical injectors are either mechanical e.g. powered by a spring, or electrical e.g. powered by a direct solenoid actuator or a motor is provided to recharge a spring. Batteries add bulk (size and weight) to a device that is desirably discrete. There is a need for miniaturisation and portability (smaller/more efficient devices). Such injectors require high peak power for very short time, (e.g. 0.1-10 seconds).

In this embodiment, a medical device, such as an injector, comprises a power supply 150 as shown in FIG. 9. At least one super-capacitor 152 is used in combination with at least one battery 154 which is dimensionally small e.g. disposable coin cell or AAA size, and which may be a low cost alkaline battery. Plural batteries 154 are serially connected. The at least one super-capacitor 152, serially connected if more than one, is connected across the at least one battery 154 so as to be progressively trickle charged thereby. A voltage regulator 156, as described earlier, is connected across the at least one super-capacitor 152. The voltage regulator 156 provides a regulated voltage, as required, to the load of the injector.

This power supply arrangement, as compared to the use of batteries alone in known devices, significantly increases the battery cycle life of low cost batteries, e.g. alkaline batteries, at a comparable cost to upgrading to high power batteries. The use of a super-capacitor allow the batteries used to have smaller dimensions, the battery being dimensioned for energy storage rather than power requirements because the batteries do not need to be sized to meet peak power. This results in a more efficient use of energy. The use of super-capacitors makes the medical device smaller, lighter, and thus truly portable. The battery may be replaced with cartridge/refill to realise very compact product designs. A super-capacitor in combination with a low cost alkaline battery significantly increases the cycle life at a comparable cost to new high power batteries.

A similar power supply could be utilised for non-medical devices, for example short burst communication periodic delivery devices.

In a particular example, an injector for medical use which has an intermittent peak power requirement per use of 5 W for 0.25 seconds, assuming three uses per day, and four hours to recharge, between uses would require a 5F capacitor. The injector would also have a small battery, e.g. two 1.2V NiMH cells, which would continuously trickle charge the capacitor. A 5F super-capacitor measures approx 8 mm diameter×30 mm in length, which is significantly smaller than two AA or two AAA cells whilst more than matching the power output. Super-capacitors provide significant opportunity for making the medical device smaller, lighter, and thus truly portable. The space previously required for a battery may now be used to hold a cartridge/refill with/without an integral button cell battery enabling a very compact product design to be realised. The above figures for this example assume mid range auto injector power requirements. Higher power can be delivered by increasing the capacitor value. However, higher rated capacitors would take longer to fully charge without increasing battery cell size. Faster charging could be achieved through the introduction of higher voltage battery cells.

In a further example of a medical sampling and delivery device, this would have similar energy requirements to the auto injector described above, although power delivery would be over a slightly extended period, typically from 0.5-5 seconds. A typical device would have three uses per day, and 4 hours to recharge, which would require a 5F capacitor. The capacitor would be trickle charged from small battery, e.g. two 1.2V NiMH cells.

In a further example of a medical device, which is a modification of the previous sampling and delivery device, as shown in FIG. 10 a replaceable package 160 comprises, in combination, a battery pack 162, comprising one or more disposable batteries, and a consumable pack 164. The battery pack 162 and the and a consumable pack 164 may be integrated into a common packaging element 166, for example a moulded plastic module, that can be inserted as a single unit into the medical device so as, in a single step, to insert fresh consumables 168 and a new battery pack 162 into the device. The consumables 168 may be disposed around, for example circumferentially around, a central portion 170 of the packaging element 166 in which the battery pack 162 is disposed. In this arrangement, the packaging element 166 may be configured such that it can be inserted directly into the device as a single recharge element, with the battery pack 162 being electrically connected to the device and the consumables being automatically located ready for sequential consumption by the device as part of the loading operation. Alternatively, the battery pack 162 and the consumable pack 164 may be integrated into a common packaging which is configured to be separable so that the consumables and the battery may be individually inserted into the device. For a sampling and delivery device the consumable pack 164 comprises a refill cassette including plural test strips or sampling points and the battery pack 162 comprises a battery having a capacity to meet energy requirements not peak power, for example a button cell. The use of a reduced size battery, as compared to known devices, provides reduced weight and size advantages over current designs. The use of an integrated battery together with the consumables ensures that there is always enough energy to completely service cassette requirements. As for the previous embodiments, a super-capacitor in the device ensures that peak power requirements and cycling frequency are met. The super-capacitor in the device ensures a more complete use of stored energy since the super-capacitor, rather than battery, delivers against energy need, providing for a more efficient use of power.

Such an embodiment is particularly suitable for a medical inhaler product in which the consumable element contains a number of pre-defined doses in a packaged form, that may or may not also include an integral battery. When the consumable cartridge is loaded into the device the battery trickle charges the super-capacitor within the device, with the super-capacitor subsequently providing the peak power to rapidly drive a solenoid. The solenoid provides the mechanical motion to impact on the dose to be delivered and rapidly transfers energy to provide a correct level of aerosolisation for inhalation. This embodiment removes the need for a compressed gas configuration as generally used currently. An electrically powered portable device according to any one of claims 1 to 18 which is a medical inhaler and the at least one capacitor is adapted to supply pulses of high electrical power to a solenoid arranged directly or indirectly to aerosolise a unit dose of an inhalation medicament for inhalation.

Accordingly, the electrically powered portable device may be a medical inhaler further comprising a replaceable package loaded therein, which package comprises, in combination, a battery pack, comprising one or more disposable batteries, and a consumable pack comprising a plurality of doses of active composition for the medical inhaler. The battery pack may comprise a button cell. The battery pack and the consumable pack may be integrated into a common packaging element which is adapted to be insertable as a single unit into the inhaler so that the battery pack is electrically connected to the inhaler and the consumable pack is inserted so that the plurality of doses of active composition are automatically loaded ready for sequential on demand dispensing by the inhaler.

In a further embodiment of the invention, the replaceable electrical power source for an electrically powered portable device comprises, in combination, a battery pack, comprising one or more disposable batteries, at least one capacitor electrically connected to the battery pack, and output terminals for the power source electrically connected to the at least one capacitor. The battery pack may comprise a button cell. The power source may further comprise a voltage regulator for regulating the output voltage of the at least one capacitor. The voltage regulator may be adapted to output a voltage having a value substantially the same as the voltage of the at least one capacitor when fully charged. The power source may be cylindrical, prismatic or custom formed in shape.

Referring to FIG. 11, a further embodiment is shown which is a medical inhaler in the form of an aerosol generating device 200 comprising an electrical power source 202 including a battery 204 in parallel with a capacitor, which is a supercapacitor 206, to provide output terminals 208. The battery 204 may drive other devices (if present), such as a display (not shown) of the medical inhaler. The output terminals 208 are connected via a switch 209 to an actuator 210, which may, for example, be a solenoid or a linear motor actuator. The actuator 210 is coupled to a piston 212 disposed in a cylinder 214 having an outlet 216 in the form of a dosing orifice. A supply of drug to be dispensed is provided in the form of a container 218 containing the drug being connected to the cylinder 214. The container 218 may be a foil bag, and may comprise a drug in the form of a liquid (although it may be a powder). A dosing device 220 at the outlet of the container 218 dispenses, on demand, a measured dose of the drug into the cylinder. The dosing orifice 216 has a predetermined shape and dimension to generate an aerosol when the measured amount of the drug is expressed therethrough under high pressure from the action of the piston.

The supercapacitor 206 is progressively charged by the battery 204, so that the supercapacitor 206 is substantially constantly fully charged. When the actuator 210 is actuated by a user by activating the switch 209, a high power electrical pulse from the supercapacitor 206 operates the actuator 210 to drive the piston 212 along the cylinder 214 towards the dosing orifice 216. The dosing device 220 dispenses a measured dose of the drug into the cylinder 214, and the measured dose is expressed as an aerosol out of the dosing orifice 216.

The preferred embodiments of the present invention provide the use of a super-capacitor to provide the instantaneous or short duration of energy required to power an electrical aerosol-generating device without the use of propellant gas. The concept can be applied to either liquid aerosols or solids/powder systems. The combination of battery/super-capacitor/pumping means and nozzle makes an effective low cost portable aerosol device, suitable for use in packaging medical or consumer products. The individual components may be assembled into more than one device to suit the needs of specific applications. In particular the device may have only the super-capacitor in the portable unit (re-charged from a base station etc) or be a completely self-contained, sealed, one-time use, disposable unit. A refill system in which the battery is integrated into the consumable unit and is rated to deliver the energy needs associated with dispensing a predetermined number of doses may be provided. The ability for this consumable element to be mated with and detached from the device such that the device provides a cost effective means for use with one or more subsequent consumable units is a significant commercial technical and advantage.

A further preferred embodiment of the present invention provides the use of a super-capacitor to provide the instantaneous or short duration of energy required to power an electrical injection device without the use of a spring or propellant gas. The combination of battery/super-capacitor/pumping means and exit component, needle or orifice for needleless injectors, makes an effective auto injector device, suitable for use in packaging medical products. The individual components may be assembled into more than one device to suit the needs of specific applications. In particular the device may have only the super-capacitor in the portable unit (re-charged from a base station etc) or be a completely self-contained, sealed, one-time use, disposable unit. A refill system in which the battery is integrated into the consumable unit and is rated to deliver the energy needs associated with dispensing a predetermined number of doses may be provided. The ability for this consumable element to be mated with and detached from the device such that the device provides a cost effective means for use with one or more subsequent consumable units is a significant commercial technical and advantage.

1. An electrically powered portable device, the device including comprising:
means for providing a function to be performed by the device,
an electrical power supply which incorporates in combination a voltage source and at least one capacitor for storing electrical charge to power the device, the voltage source and the at least one capacitor being arranged so that the voltage source progressively charges the at least one capacitor for any period that the at least one capacitor is not fully charged, wherein the voltage source continuously provides electrical power to at least one first component of the function providing means and the at least one capacitor intermittently provides high electrical power to at least one second component of the function providing means, and
electronic control circuitry to control electrical power drawn from the electrical power supply for driving the function providing means.

2. An electrically powered portable device according to claim 1 wherein the voltage source comprises at least one battery.

3. An electrically powered portable device according to claim 1 wherein the at least one battery continuously provides low electrical power to the device and the at least one capacitor intermittently provides high electrical power to the device.

4. An electrically powered portable device according to claim 1 wherein the at least one battery is removable.

5. An electrically powered portable device according to claim 5 wherein the at least one battery is packaged together with the at least one capacitor in a common package.

6. An electrically powered portable device according to claim 4 wherein the at least one battery is packaged together with at least one consumable of the device in a common package.

7. An electrically powered portable device according to claim 5 wherein the common package is removably mounted in the device.

8. An electrically powered portable device according to claim 1 wherein the or each capacitor has a capacitance of from 1 to 50 Farads.

9. An electrically powered portable device according to claim 1 wherein any one capacitor has a working output voltage of from 0.5V to 3.6V. With higher voltages achievable by configuring capacitors in series.

10. An electrically powered portable device according to claim 1 wherein the electrical power supply further comprises a voltage regulator for regulating the output voltage of the at least one capacitor.

11. An electrically powered portable device according to claim 10 wherein the voltage regulator is adapted to output a desirable voltage.

12. An electrically powered portable device according to claim 10 wherein the voltage regulator and the at least one capacitor are integrated to form a single packaged element which has a pair of input terminals and a pair of output terminals.

13. An electrically powered portable device according to claim 12 wherein the single packaged element is removable.

14. An electrically powered portable device according to claim 12 wherein the single packaged element is cylindrical, prismatic in shape or custom shaped.

15. An electrically powered portable device according to claim 1 further comprising a recharge interface for recharging the electrical power supply, the recharge interface being arranged to be electrically connectable to a charging device.

16. An electrically powered portable device according to claim 15 wherein the recharge interface is arranged to be selectively electrically connectable to a portable charging device or a charging base unit adapted to be powered by mains electrical power or battery.

17. An electrically powered portable device according to claim 15 wherein the recharge interface has a total impedance of not more than 0.3 Ohms.

18. An electrically powered portable device according to claim 1 which is a medical inhaler and the at least one capacitor is adapted to supply pulses of high electrical power to a solenoid arranged directly or indirectly to aerosolise a unit dose of an inhalation medicament for inhalation.

19. An electrically powered portable device according to claim 1 which is a spray device for generating an aerosol spray of a product, the spray device further comprising a reservoir for the product, a nozzle for discharging a spray, a delivery device to deliver the product from the reservoir to the nozzle, and an aerosol spray generator for producing an aerosol spray of the product at the nozzle, the aerosol spray generator being electrically powered by the at least one capacitor.

20. An electrically powered portable device according to claim 1 which is a medical injector and the at least one capacitor is adapted to supply pulses of high electrical power to the injector.

21. An electrically powered portable device according to claim 1 further comprising a replaceable package loaded therein, which package comprises, in combination, a battery pack, comprising one or more disposable batteries, and a consumable pack comprising at least one consumable for consumption by the electrically powered portable device.

22. An electrically powered portable device according to claim 21 wherein the consumable pack comprises a plurality of consumable doses, either individually packaged or in a bulk form.

23. An electrically powered portable device according to claim 22 wherein the plurality of consumable doses comprises a plurality of doses of active composition for a medical inhaler.

24. An electrically powered portable device according to claim 20 wherein the battery pack comprises a button cell.

25. An electrically powered portable device according to claim 20 wherein the battery pack and the consumable pack are integrated into a common packaging element which is adapted to be insertable as a single unit into the electrically powered portable device so that the battery pack is electrically connected to the device and the consumable pack is inserted so that the at least one consumable is automatically located ready for consumption by the device.

26. A replaceable package for an electrically powered portable device, which package comprises, in combination, a battery pack, comprising one or more disposable batteries, and a consumable pack comprising a plurality of consumable doses, either individually packaged or in a bulk form, for emission by the electrically powered portable device.

27. A replaceable package according to claim 26 wherein the plurality of consumable doses comprises a plurality of pre-dosed active composition for a medical inhaler.

28. A replaceable package according to claim 26 wherein the battery pack comprises a button cell.

29. A replaceable package according to claim 26 wherein the battery pack and the consumable pack are integrated into a common packaging element which is adapted to be insertable as a single unit into the electrically powered portable device so that the battery pack is electrically connected to the device and the consumable pack is inserted so that the at least one consumable is automatically located ready for consumption by the device.

30. An electrical power source for an electrically powered portable device, which power source comprises, in combination, a battery pack, comprising one or more disposable batteries, at least one capacitor electrically connected to the battery pack, a voltage regulator for regulating the output voltage of the at least one capacitor, the voltage regulator being adapted to output a desirable voltage for the application, and output terminals for the power source electrically connected to the at least one capacitor.

31. An electrical power source for an electrically powered portable device according to claim 30 wherein the battery pack comprises a button cell.

32. An electrical power source for an electrically powered portable device according to claim 30 wherein the power source is cylindrical, prismatic in shape or custom shaped.

33. An electrically powered portable medical inhaler, the medical inhaler comprising:
function providing means including any powered delivery means for converting electrical energy into fluid or powder flow at the desired high pressure and flow rate, such as a displacement pump, a solenoid, or another mechanical actuator arranged directly or indirectly to aerosolise a unit dose of an inhalation medicament for inhalation,
an electrical power supply which incorporates in combination a voltage source and at least one capacitor for storing electrical charge to power the inhaler, the voltage source and the at least one capacitor being arranged so that the voltage source progressively charges the at least one capacitor for any period that the at least one capacitor is not fully charged, wherein the at least one capacitor intermittently provides pulses of high electrical power to at least the solenoid, and
electronic control circuitry to control electrical power drawn from the electrical power supply for driving the function providing means.

34. An electrically powered portable spray device for generating an aerosol spray of a product, the spray device comprising:
a reservoir for the product,
a nozzle for discharging a spray,
a delivery device to deliver the product from the reservoir to the nozzle,
an aerosol spray generator for producing an aerosol spray of the product at the nozzle,
an electrical power supply which incorporates in combination a voltage source and at least one capacitor for storing electrical charge to power the device, the voltage source and the at least one capacitor being arranged so that the voltage source progressively charges the at least one capacitor for any period that the at least one capacitor is not fully charged, wherein the at least one capacitor intermittently provides high electrical power to at least the aerosol spray generator, and
electronic control circuitry to control electrical power drawn from the electrical power supply for driving at least the aerosol spray generator.

35. An electrically powered portable medical injector, the medical injector comprising:
an injection means,
an electrical power supply which incorporates in combination a voltage source and at least one capacitor for storing electrical charge to power the injector, the voltage source and the at least one capacitor being arranged so that the voltage source progressively charges the at least one capacitor for any period that the at least one capacitor is not fully charged, wherein the at least one capacitor intermittently provides pulses of high electrical power to the injection means, and
electronic control circuitry to control electrical power drawn from the electrical power supply for driving the injection means.

36. A medical inhaler in the form of an aerosol generating device, the medical inhaler comprising:
an electrical power source including a battery in parallel with a supercapacitor to provide output terminals connected to an actuator, the actuator is coupled to a piston disposed in a cylinder having an outlet in the form of a dosing orifice,
a container containing a supply of a drug to be dispensed is connected to the cylinder, and
a dosing device is provided at the outlet of the container to dispense a measured dose of the drug into the cylinder, and the dosing orifice has a predetermined shape and dimension to generate an aerosol when the measured amount of the drug is expressed therethrough under pressure from the action of the piston operated by the actuator.
